(19) United States
(12) Patent Application Publication
(10) Pub. No.: US 2024/0052195 A1
(43) Pub. Date: Feb. 15, 2024

(54) POLYESTER POLYOL COMPOSITIONS FOR METAL PACKAGING COATINGS

(71) Applicant: Eastman Chemical Company, Kingsport, TN (US)

(72) Inventors: Linqian Feng, Johnson City, TN (US); Cameron Lee Brown, Kingsport, TN (US); John Thorton Maddox, Jonesborough, TN (US); Alain Michel Cagnard, Kingsport, TN (US); Selene Ayde De Leon Ibarra, Kingsport, TN (US); Thauming Kuo, Kingsport, TN (US)

(73) Assignee: Eastman Chemical Company, Kingsport, TN (US)

(21) Appl. No.: 18/247,896

(22) PCT Filed: Oct. 21, 2021
(86) PCT No.: PCT/US2021/055985

§ 371 Date: Apr. 5, 2023

Related U.S. Application Data
(60) Provisional application No. 63/106,065, filed on Oct. 27, 2020.

(51) Int. Cl. C09D 167/02; C08G 63/127; C08G 63/199; C08G 63/20

(52) U.S. Cl. CPC C09D 167/02; C08G 63/127; C08G 63/199; C08G 63/20; C08G 2150/90

(57) ABSTRACT

This invention pertains to improved polyester polyol compositions comprising 1,3-cyclohexanedimethanol (1,3-CHDM). Coating compositions based on such polyester polyols are capable of providing a good balance of the desirable coating properties, such as solvent resistance, acid resistance, retort resistance, microcracking resistance, and bending ability, for metal packaging applications.

### FIELD OF THE INVENTION

This application relates to chemistry in general. In particular, this application relates to polyester compositions. More particularly this application relates to polyester compositions containing 1,3-cyclohexanedimethanol (1,3-CHDM) for use in coating metals.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between filled product and metal, a coating is typically applied to the interior of the food and beverage cans. In order to be effective, such a coating must have adequate properties that are needed for protecting the packaged products, such as adhesion, corrosion resistance, chemical resistance, flexibility, stain resistance, and hydrolytic stability. Moreover, the coating must be able to withstand processing conditions during can fabrication and food sterilization. Coatings based on a combination of epoxy and phenolic resins are known to be able to provide a good balance of the required properties and are most widely used. There are industry sectors moving away from food contact polymers made with bisphenol A (BPA), a basic building block of epoxy resins. Thus, there exists a desire for the replacement of epoxy resin used in interior can coatings.

Polyester resins are of particular interest to the coating industry to be used as a replacement for epoxy resin because of their comparable properties such as flexibility and adhesion. 2,2,4,4-Tetramethyl-1,3-cyclobutanediol (TMCD) is a cycloaliphatic compound that can be used as a diol component for making polyesters. Thermoplastics based on TMCD polyester exhibit improved impact resistance owing to TMCD's unique structure. TMCD can also provide improved hydrolytic stability of the polyester due to its secondary hydroxyl functionality. Both of these properties are highly desirable in thermosetting coatings.

Polyesters based on TMCD exhibit higher glass transition temperatures, which is desirable for coatings capable of withstanding processing conditions during can fabrication. High Tg polyesters are also desirable for food sterilization at high temperatures. Coatings based on such polyesters, however, tend to be less flexible, which can have detrimental effects on microcracking (crazing) resistance and bending ability during processing. Thus, there remains a need to discover a suitable polyester composition that can provide a good balance of the desirable coating properties for metal packaging applications.

### SUMMARY OF THE INVENTION

In one embodiment, this invention provides a coating composition for metal packaging comprising: a coating composition for metal packaging applications, comprising:
a) a polyester polyol, which is the reaction product of the monomers comprising:
   i) 1,3-cyclohexanedimethanol (1,3-CHDM) in an amount of 35-97 mole %, based on the total moles of i-iii,
   ii) a diol other than 1,3-CHDM in an amount of 0-50 mole %, based on the total moles of i-iii,
   iii) trimethylolpropane (TMP) in an amount of 3-15 mole %, based on the total moles of i-iii,
   iv) terephthalic acid (TPA) in an amount of 10-50 mole %, based on the total moles of iv-vi,
   v) isophthalic acid (IPA) in an amount of 50-90 mole %, based on the total moles of iv-vi, and
   vi) an aliphatic diacid in an amount of 0-20 mole %, and, based on the total moles of iv-vi, and
b) one or more crosslinkers selected from the group consisting of resole phenolic resin, isocyanate, and amino resin crosslinkers, and

wherein said polyester polyol has a glass transition temperature (Tg) of 50-80° C.), acid number of 0-10 mgKOH/g, hydroxyl number of 15-45 mgKOH/g, number average molecular weight of 3000-20000 g/mole, and weight average molecular weight of 10000-150000 g/mole; and wherein said coating has a solvent resistance of greater than 50 MEK double rubs as measured by ASTM D7835 and a wedge bend resistance (% pass) of 70-100 as measured by the method of ASTM D3281.

In another embodiment, this invention provides a coating composition for metal packaging comprising:
a) polyester polyol in an amount of 60-80 weight %, based on the total weight of (a), (b), and (c), which is the reaction product of the monomers comprising:
   i) 1,3-cyclohexanedimethanol (1,3-CHDM) in an amount of 35-97 mole %, based on the total moles of i-iii,
   ii) a diol other than 1,3-CHDM in an amount of 0-50 mole %, based on the total moles of i-iii,
   iii) trimethylolpropane (TMP) in an amount of 3-15 mole %, based on the total moles of i-iii,
   iv) terephthalic acid (TPA) in an amount of 10-50 mole %, based on the total moles of iv-v,
   v) isophthalic acid (IPA) in an amount of 50-90 mole %, based on the total moles of iv-vi, and
   vi) an aliphatic diacid in an amount of 0-20 mole %, and, based on the total moles of iv-vi,
b) a resole phenolic resin in an amount of 15-30 weight % based on the total weight of (a), (b), and (c), and
c) isophorone diisocyanate (IPDI) in an amount of 5-15 weight % based on the total weight of (a), (b), and (c),

wherein said polyester polyol has a glass transition temperature (Tg) of 55 to 70° C., acid number of 0 to 10 mgKOH/g, hydroxyl number of 25 to 35 mgKOH/g, number average molecular weight of 5,000 to 20,000 mgKOH/g, and weight average molecular weight of 10,000 to 150,000; and wherein said coating has a solvent resistance of greater than 80 MEK double rubs as measured by ASTM D7835 and a wedge bend resistance (% pass) of 70-100 as measured by the method of ASTM D3281.

### BRIEF DESCRIPTION OF THE DRAWING

FIG. 1 illustrates a modified Metal Bead Roller forming beads on a metal sheet.

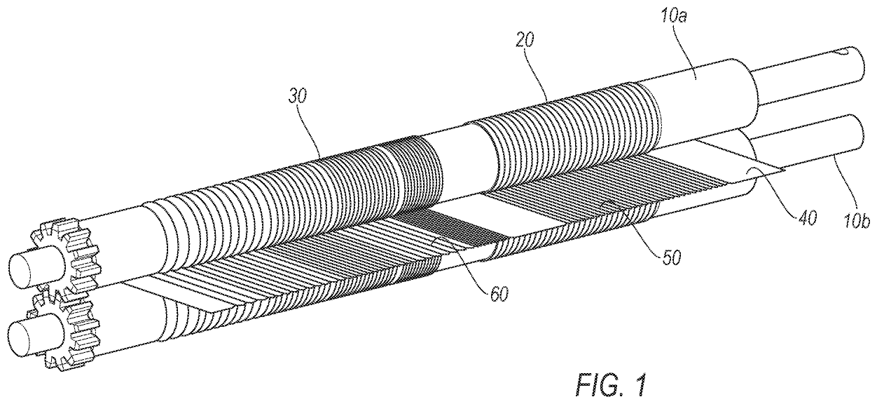

### DETAILED DESCRIPTION

In this specification and in the claims that follow, reference will be made to a number of terms, which shall be defined to have the following meanings.

“Alcohol” means a chemical containing one or more hydroxyl groups.

“Aldehyde” means a chemical containing one or more —C(O)H groups.

“Acyclic” means a compound or molecule having no rings of atoms in the compound's structure.

“Aliphatic” means a compound having a non-aromatic structure.

“Diacid” means a compound having two carboxyl functional groups.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Chosen from” as used herein can be used with “or” or “and.” For example, Y is chosen from A, B, and C means Y can be individually A, B, or C. Alternatively, Y is chosen from A, B, or C means Y can be individually A, B, or C; or a combination of A and B, A and C, B and C, or A, B, and C.

As used herein numerical ranges are intended to include the beginning number in the range and the ending number in the range and all numerical values and ranges in between the beginning and ending range numbers. For example, the range 40° C. to 60° C. includes the ranges 40° C. to 59° C., 41° C. to 60° C., 41.5° C. to 55.75° C. and 40°, 41°, 42°, 43°, etc. through 60° C.

Disclosed herein is an unexpected discovery that coating compositions based on certain polyester polyol compositions comprising 1,3-CHDM are capable of providing a good balance of the desirable coating properties, such as solvent resistance, acid resistance, retort resistance, microcracking resistance, and bending ability, for metal packaging applications.

Thus, in one embodiment of the invention, there is provided a coating composition having improved coating properties for metal packaging application, which comprises:
a. a polyester polyol, which is the reaction product of the monomers comprising:
   i. 1,3-cyclohexanedimethanol (1,3-CHDM) in an amount of 35-97 mole %, based on the total moles of i-iii,
   ii. a diol other than 1,3-CHDM in an amount of 0-50 mole %, based on the total moles of i-iii,
   iii. trimethylolpropane (TMP) in an amount of 3-15 mole %, based on the total moles of i-iii,
   iv. terephthalic acid (TPA) in an amount of 10-50 mole %, based on the total moles of iv-vi,
   v. isophthalic acid (IPA) in an amount of 50-90 mole %, based on the total moles of iv-vi, and
   vi. an aliphatic diacid in an amount of 0-20 mole %, and, based on the total moles of iv-vi, and
b. one or more crosslinkers selected from the group consisting of resole phenolic resin, isocyanate, and amino resin crosslinkers,

wherein said polyester polyol has a glass transition temperature (Tg) of 50-80° C., acid number of 0-10 mgKOH/g, hydroxyl number of 15-45 mgKOH/g, number average molecular weight of 3000-20000 g/mole, and weight average molecular weight of 10000-150000 g/mole; and wherein said coating has a solvent resistance of greater than 70 MEK double rubs as measured by ASTM D7835 and a wedge bend resistance (% pass) of 70-100 as measured by the method of ASTM D3281.

In a further embodiment, said coating has a microcracking resistance rating of 1.5-5, a total retort resistance rating (%) of 70-100, and a 5% acetic acid vapor resistance rating (%) of 40-100, as measured by the methods specified in the example section.

In some embodiments of the invention, said 1,3-CHDM (i) is in an amount of 35-97, 65-95, or 83-93 mole % based on the total moles of (i)-(ii).

In some embodiments of the invention, said diol other than 1,3-CHDM (ii) is in an amount of 0-50, 0-30, or 0-10 mole % based on the total moles of (i)-(iii).

In some embodiments of the invention, said TMP (iii) is in an amount of 3-15, 5-12, or 7-10 mole %, based on the total moles of (i)-(iii);

In some embodiments of the invention said TPA (iv) is in an amount of 10-50, 15-40, or 20-30 mole %, based on the total moles of (iv)-(vi).

In some embodiments of the invention said IPA (v) is in an amount of 50-90, 55-80, or 62-72 mole %, based on the total moles of (iv)-(vi).

In some embodiments of the invention said aliphatic diacid (vi) is in an amount of 0-20, 5-15, and 8-12 mole %, based on the total moles of (iv)-(vi).

In another embodiment, 1,3-CHDM (i) is in an amount of 83-93 mole % based on the total moles of (i)-(iii), the diol other than 1,3-CHDM (ii) is in an amount of 0-10 mole % based on the total moles of (i)-(iii), TMP (iii) is in an amount of 7-10 mole % based on the total amount of (i)-(iii); TPA (iv) is present in an amount of 20-30 mole % based on the total amount of (iv)-(vi), IPA (v) is present in an amount of 62-72 mole % based on the total amount of (iv)-(vi), and the aliphatic diacid (vi) is present in an amount of 8-12 mole %, based on the total amount of (iv)-(vi).

Said diol other than 1,3-CHDM (ii) includes 1,4-cyclohexanedimethanol (1,4-CHDM), 2-methyl-1,3-propanediol (MPdiol), neopentyl glycol (NPG), isosorbide, and mixtures thereof. Desirably, said diol other than 1,3-CHDM is 1,4-CHDM.

Said TPA includes terephthalic acid and its esters such as dimethyl terephthalate.

Said IPA includes isophthalic acid and its esters such as dimethyl isophthalate.

Said aliphatic diacid includes C₄-C₁₂ diacids and their esters, such as succinic acid, adipic acid, sebacic acid, dodecanedioic acid, cyclohexane dicarboxylic acid, and their methyl esters; and (hydrogenated) dimer acid (C₃₆). Desirably, when longer chain diacids (>C₁₀) are used, they are at a smaller ratio such as 1-10, 1-5, 1-3, or 1-2 mole %. In one aspect, said aliphatic diacid is sebacic, adipic acid, or a mixture thereof at a ratio of 8-12 mole %.

Said polyester polyol has a glass transition temperature (Tg) of 50-80° C., 53-75° C., or 55-70° C.

Said polyester polyol has a number average weight of 5,000-20,000, 6,000-15,000, or 7,000-13,000 g/mole; weight average weight of 10,000-100,000, 12,000-90,000, or 14,000-80,000 g/mole.

Said polyester polyol has an acid number of 0-10, 0-8, 0-5, 0-3, 0-2, or 0-1 mgKOH/g.

Said polyester polyol has a hydroxyl number of 15-45, 20-40, or 25-35 mgKOH/g.

In another embodiment, the coating composition of the present invention comprises said polyester polyol (a) in an amount of 50-90 weight % and said crosslinker (b) in an amount of 10-50 weight %, based on the total weight of (a) and (b). In some embodiments, the polyester polyol (a) is in 55-85, 60-80, 65-85, 65-80, 65-75, 70-90, 70-85, 70-80, 75-85, 80-90, or 80-85 weight %; and the crosslinker (b) in 15-45, 20-40, 15-35, 20-35, 25-35, 10-30, 15-30, 20-30, 15-25, 10-20, or 15-20 weight %.

Said crosslinker (b) is one or more selected from the group consisting of resole phenolic resin, isocyanate, and amino resin crosslinkers. Desirably, the crosslinker is resole phenolic resin, isocyanate, or a mixture thereof.

Said resole phenolic resin contains the residues of un-substituted phenol and/or meta-substituted phenols. These particular resole resins exhibit good reactivity with said polyester polyol (a). Desirably, the amount of the resole phenolic resin is at least 50 wt. % or greater than 60 wt. % or greater than 70 wt. % or greater than 80 wt. % or greater than 90 wt. % based on the weight of all cross-linker compounds.

The resole phenolic resin present in the crosslinking composition contains methylol groups on the phenolic rings. Phenolic resins having methylol functionalities are referred to as resole type phenolic resins. As is known in the art, the methylol group (—CH₂OH) may be etherated with an alcohol and present as —CH₂OR, wherein R is C₁-C₈ alkyl group, in order to improve resin properties such as storage stability and compatibility. For purpose of the description, the term “methylol” used herein includes both —CH₂OH and —CH₂OR, and an un-substituted methylol group is CH₂OH. Said methylol groups (either —CH₂OH or —CH₂OR) are the end groups attached to the resole resins. The methylol groups are formed during the resole resin synthesis and can further react with another molecule to form ether or methylene linkages leading to macromolecules.

The phenolic resin contains the residues of un-substituted phenols or meta-substituted phenols. When starting with phenol or meta-substituted phenols to make a resole, the para and ortho positions are both available for bridging reactions to form a branched network with final methylol end groups on the resin being in the para or ortho positions relative to the phenolic hydroxyl group. To make the phenolic resole, a phenol composition is used as a starting material. The phenol composition contains un-substituted and/or meta-substituted phenols. The amount of un-substituted, meta-substituted, or a combination of the two, that is present in the phenol compositions used as a reactant to make the phenolic resole resin, is at least 50 wt. %, or at least 60 wt. %, or at least 70 wt. %, or at least 75 wt. %, or at least 80 wt. %, or at least 85 wt. %, or at least 90 wt. %, or at least 95 wt. %, or at least 98 wt. %, based on the weight of the phenol composition used as a reactant starting material.

The phenol composition is reacted with a reactive compound such as an aldehyde at an aldehyde:phenol molar ratio (using aldehyde as an example) of greater than 1:1, or at least 1.05:1, or at least 1.1:1, or at least 1.2:1, or at least 1.25:1, or at least 1.3:1, or at least 1.35:1, or at least 1.4:1, or at least 1.45:1, or at least 1.5:1, or at least 1.55:1, or at least 1.6:1, or at least 1.65:1, or at least 1.7:1, or at least 1.75:1, or at least 1.8:1, or at least 1.85:1, or at least 1.9:1, or at least 1.95:1, or at least 2:1. The upper amount of aldehyde is not limited and can be as high as 30:1, but generally is up to 5:1, or up to 4:1, or up to 3:1, or up to 2.5:1. Typically, the ratio of aldehyde:phenol is at least 1.2:1 or more, or 1.4:1 or more or 1.5:1 or more, and typically up to 3:1. Desirably, these ratios also apply to the aldehyde/unsubstituted phenol or meta-substituted phenol ratio.

The resole phenolic resin can contain an average of at least 0.3, or at least 0.4, or at least 0.45, or at least 0.5, or at least 0.6, or at least 0.8, or at least 0.9 methylol groups per one phenolic hydroxyl group, and “methylol” includes both —CH₂OH and —CH₂OR.

The phenolic resin obtained by the condensation of phenols with aldehydes of the general formula (RCHO)n, where R is hydrogen or a hydrocarbon group having 1 to 8 carbon atoms and n is 1, 2, or 3. Examples include formaldehyde, paraldehyde, acetaldehyde, glyoxal, propionaldehyde, furfuraldehyde, or benzaldehyde. Desirably, the phenolic resin is the reaction product of phenols with formaldehyde.

At least a part of the crosslinker in (b) comprises a resole type phenolic resin that is prepared by reacting either un-substituted phenol or meta-substituted phenol or a combination thereof with an aldehyde. The unsubstituted phenol is phenol (C₆H₅OH). Examples of meta-substituted phenols include m-cresol, m-ethylphenol, m-propylphenol, m-butylphenol, moctylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dicyclohexyl phenol, 3,5-dimethoxy phenol, 3-alkyl-5-alkyoxy phenol, and the like.

Although other substituted phenol compounds can be used in combination with said un-substituted phenols or meta-substituted phenols for making phenolic resins, it is desirable that at least 50%, or at least 70%, or at least 80%, or at least 90%, or at least 95%, or at least 98%, or at least 100% of the phenolic compounds used to make the resole resin are unsubstituted phenol or meta-substituted phenol.

In one aspect, the resole phenolic resin used in this invention comprises residues of m-substituted phenol.

Examples of suitable commercial phenolic resins include, but are not limited to, PHENODUR® PR 516/60B (based on cresol and formaldehyde) available from Allnex, PHENODUR® PR 371/70B (based on unsubstituted phenol and formaldehyde) also available from Allnex, and CURAPHEN 40-856 B60 (based on m-cresol and formaldehyde) available from Bitrez.

The phenolic resins are desirably heat curable. The phenolic resin is desirably not made by the addition of bisphenol A, F, or S (collectively “BPA”).

The resole is desirably of the type that is soluble in alcohol. The resole resin can be liquid at 25° C. The resole resin can have a weight average molecular weight from 200 to 2000, generally from 300 to 1000, or from 400 to 800, or from 500 to 600.

The isocyanate crosslinker suitable for this invention may be blocked or unblocked isocyanate type. Examples of suitable isocyanate crosslinkers include, but are not limited to, 1,6-hexamethylene diisocyanate, methylene bis(4-cyclohexyl isocyanate), and isophorone diisocyanate. Desirably, the isocyanate crosslinker is isophorone diisocyanate (IPDI) or blocked IPDI available from COVESTRO as Desmodur® BL 2078/2.

In some embodiments, the crosslinker (b) is a mixture of CURAPHEN 40-856 B60 available from Bitrez and blocked isophorone diisocyanate (IPDI).

In another embodiment, the crosslinker (b) is a mixture of resole phenolic resin in an amount of 70-90 weight % and isocyanate in an amount of 10-30 weight %, based on the total weight of the crosslinkers.

In addition to resole phenolic resin and isocyanate, said crosslinker (b) may also be amino resin. The amino resin crosslinker (or cross-linking agent) can be a melamine-formaldehyde type or benzoguanamine-formaldehyde type cross-linking agent, i.e., a cross-linking agent having a plurality of —N(CH₂OR₃)₂ functional groups, wherein R³ is C1-C4 alkyl, preferably methyl.

In still another embodiment, the crosslinker (b) is a mixture of amino resin in an amount of 50-70 weight % and isocyanate in an amount of 30-50 weight %, based on the total weight of the crosslinkers.

In general, the amino cross-linking agent may be selected from compounds of the following formulae, wherein R³ is independently C1-C4 alkyl:

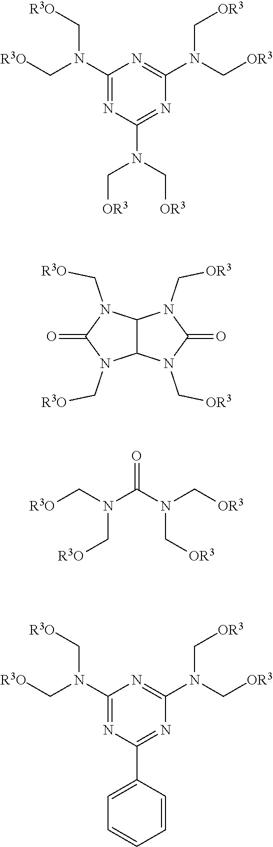

The amino containing cross-linking agents are desirably hexamethoxymethylmelamine, tetramethoxymethylbenzoguanamine, tetramethoxymethylurea, mixed butoxy/methoxy substituted melamines, and the like.

Desirably, in all the types of thermosetting compositions, the cross-linker composition contains greater than 50 wt. % or greater than 60 wt. % or greater than 70 wt. % or greater than 80 wt. % or greater than 90 wt. % resole phenolic resin, based on the weight of the cross-linker composition. In addition to or in the alternative, the remainder of the cross-linking compounds in the cross-linking composition, if any, are amine based crosslinking compounds as described above and/or isocyanate crosslinker.

Any of the thermosetting compositions of the invention can also include one or more cross-linking catalysts. Representative crosslinking catalysts include from carboxylic acids, sulfonic acids, tertiary amines, tertiary phosphines, tin compounds, or combinations of these compounds. Some specific examples of crosslinking catalysts include p-toluenesulfonic acid, phosphoric acid, the NACURE™ 155, 5076, 1051, and XC-296B catalysts sold by King Industries, BYK 450, 470, available from BYK-Chemie U.S.A., methyl tolyl sulfonimide, p-toluenesulfonic acid, dodecylbenzene sulfonic acid, dinonylnaphthalene sulfonic acid, and dinonylnaphthalene disulfonic acid, benzoic acid, triphenylphosphine, dibutyltindilaurate, and dibutyltindiacetate.

The crosslinking catalyst can depend on the type of crosslinker that is used in the coating composition. For example, the crosslinker can comprise a melamine or “amino” crosslinker and the crosslinking catalyst can comprise p-toluenesulfonic acid, phosphoric acid, unblocked and blocked dodecylbenzene sulfonic (abbreviated herein as “DDBSA”), dinonylnaphthalene sulfonic acid (abbreviated herein as “DNNSA”) and dinonylnaphthalene disulfonic acid (abbreviated herein as “DNNDSA”). Some of these catalysts are available commercially under trademarks such as, for example, NACURE™ 155, 5076, 1051, 5225 and XC-296B (available from King Industries), BYK-CATALYSTS™ (available from BYK-Chemie USA), and CYCAT™ catalysts (available from Cytec Surface Specialties). The coating compositions of the invention can comprise one or more isocyanate crosslinking catalysts such as, for example, FASCAT™ 4202 (dibutyltindilaurate), FASCAT™ 4200 (dibutyltindiacetate, both available from Arkema), DABCO™ T-12 (available from Air Products) and K-KAT™ 348, 4205, 5218, XC-6212™ non-tin catalysts (available from King Industries), and tertiary amines.

The coating composition can contain an acid or base catalyst in an amount ranging from 0.1 to 2 weight %, based on the total weight of any of the aforementioned curable polyester resins and the crosslinker composition.

In another embodiment, the coating composition of the present invention further comprises one or more organic solvents. Suitable organic solvents include xylene, ketones (for example, methyl amyl ketone), 2-butoxyethanol, ethyl-3-ethoxypropionate, toluene, butanol, cyclopentanone, cyclohexanone, ethyl acetate, butyl acetate, Aromatic 100 and Aromatic 150 (both available from ExxonMobil), and other volatile inert solvents typically used in industrial baking (i.e., thermosetting) enamels, mineral spirits, naptha, toluene, acetone, methyl ethyl ketone, methyl isoamyl ketone, isobutyl acetate, t-butyl acetate, n-propyl acetate, isopropyl acetate, methyl acetate, ethanol, n-propanol, isopropanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate (available commercially from Eastman Chemical Company under the trademark TEXANOL™), or combinations thereof.

The amount of solvents is desirably at least 20 wt. %, or at least 25 wt. %, or at least 30 wt. %, or at least 35 wt. %, or at least 40 wt. %, or at least 45 wt. %, or at least 50 wt. %, or at least 55 wt. % based on the weight of the solvent containing coating composition. Additionally, or in the alternative, the amount of organic solvents can be up to 85 wt. % based on the weight of the coating composition.

In some embodiments of the invention, the coating has a solvent resistance as measured by the method of ASTM D7835 of greater than 70 MEK double rubs or greater than 80 MEK double rubs, or greater than 90, or greater than 100 MEK double rubs, or 70 to 100, 80 to 100, or 90 to 100 MEK double rubs as measured by the method of ASTM D7835.

In some embodiments of the invention the coating has a wedge bend resistance (% pass) of 70-100, 75-100, or 80-100 as measured by the method of ASTM D3281.

In further embodiments of the invention, the coating has a microcracking resistance rating (%) of 1.5-5, 2-5, or 2.5-5, a total retort resistance rating (%) of 70-100, 80-100, or 90-100, and a 5% acetic acid vapor resistance rating of 40-100, 50-100, 60-100, 70-100, 80-100, 90-100 as measured by the methods specified in the Example section.

In a further embodiment, this invention provides a coating composition for gold-color coating having improved coating properties for metal packaging application, which comprises:
a. a polyester polyol in an amount of 60-80 weight %, based on the total weight of (a), (b), and (c), which is the reaction product of the monomers comprising:
   i. 1,3-cyclohexanedimethanol (1,3-CHDM) in an amount of 35-97 mole %, based on the total moles of i-iii,
   ii. a diol other than 1,3-CHDM in an amount of 0-50 mole %, based on the total moles of i-iii,
   iii. trimethylolpropane (TMP) in an amount of 3-15 mole %, based on the total moles of i-iii,
   iv. terephthalic acid (TPA) in an amount of 10-50 mole %, based on the total moles of iv-vi,
   v. isophthalic acid (IPA) in an amount of 50-90 mole %, based on the total moles of iv-vi, and
   vi. an aliphatic diacid in an amount of 0-20 mole %, and, based on the total moles of iv-vi,
b. a resole phenolic resin in an amount of 15-30 weight % based on the total weight of (a), (b), and (c), and
c. isophorone diisocyanate (IPDI) in an amount of 5-15 weight % based on the total weight of (a), (b), and (c),

wherein said polyester polyol has a glass transition temperature (Tg) of 55 to 70° C., acid number of 0 to 10 mgKOH/g, hydroxyl number of 25 to 35 mgKOH/g, number average molecular weight of 5,000 to 20,000 mgKOH/g, and weight average molecular weight of 10,000 to 150,000; and wherein said coating has MEK double rubs of 80 to 100 or greater as measured by the method of ASTM D7835 and a wedge bend resistance (% pass) of 70-100 as measured by the method of ASTM D3281. In a further embodiment, said coating has a microcrack resistance rating of 2.5-5, a total retort resistance rating of 80-100, and a 5% acetic acid vapor resistance rating of 40-100, as measured by the methods specified in the example section.

The coating composition may also comprise at least one pigment. Typically, the pigment is present in an amount of about 20 to about 60 weight percent, based on the total weight of the composition. Examples of suitable pigments include titanium dioxide, barytes, clay, calcium carbonate, and CI Pigment White 6 (titanium dioxide). For example, the solvent-borne, coating formulations can contain titanium dioxide as the white pigment available from CHEMOURS as Ti-Pure™ R 900.

After formulation, the coating composition can be applied to a substrate or article. Thus, a further aspect of the present invention is a shaped or formed article that has been coated with the coating compositions of the present invention. The substrate can be any common substrate such as aluminum, tin, steel or galvanized sheeting; urethane elastomers; primed (painted) substrates; and the like. The coating composition can be coated onto a substrate using techniques known in the art, for example, by spraying, draw-down, roll-coating, etc., about 0.1 to about 4 mils (1 mil=25 μm), or 0.5 to 3, or 0.5 to 2, or 0.5 to 1 mils of wet coating onto a substrate. The coating can be cured at a temperature of about 50° C. to about 230° C., for a time period that ranges from about 5 seconds to about 90 minutes and allowed to cool. Examples of coated articles include metal cans for food and beverages, in which the interiors are coated with the coating composition of the present invention.

Thus, this invention further provides an article, of which at least a portion is coated with the coating composition of the present invention.

### EXAMPLES

This invention can be further illustrated by the following examples thereof, although it will be understood that these examples are included merely for purposes of illustration and are not intended to limit the scope of the invention unless otherwise specifically indicated.

### Abbreviations

mL is milliliter; wt % is weight percent; eq is equivalent(s); hrs or h is hour(s); mm is millimeter; m is meter; ° C. is degree Celsius; min is minute; g is gram; mmol is millimole; mol is mole; kg is kilogram; L is liter; w/v is weight/volume; μL is microliter; MW is molecular weight.

### Coating Test Methods:

### Substrate, Coated Test Panel Preparation, Film Weight

Electro tin plate (ETP) substrate panels were supplied by two vendors, Lakeside Metals Inc.—0.23 mm thickness, 2.2 g/m² tin content, temper and annealing type T61CA, and Reynolds Metals Company—0.19 mm thickness, 2.2 g/m² tin content, temper and annealing type DR-8CA. The substrates were coated with the formulations by casting wet films with wire wound rods, RDS 14 for pigmented and RDS 10 for gold (RDS 14 and RDS 10 available from R.D. Specialties, Inc.). This yielded a final dry film weight of approximately 14-16 grams/m² for pigmented coatings and approximately 6-8 grams/m² for coatings containing phenolic resin crosslinker, which showed gold color when cured (gold coatings), respectively. For microcracking test, the formulations were applied by casting wet films with wire wound rods—RDS 5 (available from R.D. Specialties, Inc.) which yielded a dry film weight of 3.0-3.5 gram/m². The cast panels were placed in a rack vertically and held in oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool to ambient conditions. A Sencon SI9600 coating thickness gauge was used to confirm the dry film weight of the applied coatings.

### Wedge Bend

A coupon measuring 1.5″ wide×4″ long was cut from the coated panel. This coupon was tested by a Gardco coverall bend and impact tester following ASTM D 3281. To make a bend test, the coated coupon was first bent over the ⅛″ (0.32 cm) steel rod. The bent coupon was placed between the parts of a butt hinge. The hinge made of two steel blocks is attached to the base below the guide tube. When the hinge is closed, it creates a wedge shape gap between the upper and lower parts ranging from ⅛″ at the hinged end to zero thickness at the free end. Then the impact tool, flat face down, was dropped from a height of one or two feet onto the upper part of the hinge. Once coated coupon was bent and impacted into a wedge shape, it was then soaked in an acidified copper sulfate solution (5 wt % copper sulfate, 15 wt % hydrochloric acid (35%), 80 wt % distilled water) for 5 minutes to make any coating cracking visible. Excess copper sulfate solution was removed by washing with water and blotting with a dry towel. Wedge bend failure (mm) measured by using a ruler and a lighted magnifying glass is defined as the total length of continuous crack along the bent edge of the coupon. The result is reported as Pass % of wedge bend which is calculated by:

$$Pass \% of wedge bend = \frac{( Total length - wedge bend failure )}{Total length} \times 100 \%$$

Each Pass % of wedge bend in this experiment is an average value from 3 replicates.

### Methyl Ethyl Ketone (MEK) Double Rubs

The resistance to MEK solvent was measured using a MEK rub test machine (Gardco MEK Rub Test Machine AB-410103EN with 1 kg block). This test was carried out similarly to ASTM D7835. MEK solvent resistance was reported as the number of double rubs a coated panel can take before the coating starts to be removed. For example, one back-and-forth motion constitutes one double rub. A maximum of 100 double rubs was set as the upper limit for each evaluation.

### Sterilization Resistance Testing (Total Retort Testing)

A coated coupon measuring 2.5″ wide×4″ long was cut from the coated panel. The coupons were then placed in 16 oz wide mouth Le Parfait glass jar half filled with the food simulant where half the coupon is above food simulant liquid and the other half is submerged in food simulant liquid. Two different food simulants were evaluated:
Lactic acid: 2% lactic acid, 98% deionized water.
Acetic Acid: 3% acetic acid, 97% deionized water.

The jars with properly closed top were placed in an autoclave, Priorclave Model PNA/QCS/EH150, for 1 hr at 131° C. Once the retort process was finished, the autoclave was allowed to depressurize to ambient conditions. After the completion of sterilization cycle, the glass jars containing the test coupons were then removed from the autoclave. The coupons were removed from the jars and wash under water and blotted dry with paper towels. Typically, the retort performance is rated on a scale of 0 (worst) to 5 (best) using a visual observation. For each food simulant, the retort performance was rated on (1) blush at vapor phase, (2) blush at liquid phase, (3) rough ness at vapor phase, (4) roughness at liquid phase and (5) cross-hatch adhesion (following ASTM D 3359) at liquid phase, respectively. An overall retort performance is reported as Total Retort % is calculated by:

$$Total Retort \% = \frac{\begin{matrix}Sum of rating ( 1 ) to ( 5 ) from 2 \% lactic acid + \\ Sum of rating ( 1 ) to ( 5 ) from 3 \% acetic acid\end{matrix}}{50} \times 100 \%$$

Each retort rating in this experiment is an average rating from 2 replicates.
5% Acetic acid Vapor Test

To perform the test, a can end (with Ø 307 can end dimension) was fabricated from a coated panel prepared by the standard methods and film weight. With a rubber O-ring fitted into the counter area of a fabricated can end, the can end with coating on the interior was then used as a lid and properly sealed on top of a 16 oz wide mouth Le Parfait glass jar filled with 5% Acetic acid food simulant (5% acetic acid, 95% deionized water). Like sterilization test, the jars with properly closed top were placed in an autoclave, Priorclave Model PNA/QCS/EH150, for 1 hr at 131° C. Once the retort process was finished, the autoclave was allowed to depressurize to ambient conditions. Then the glass jars with coated can ends were then removed from the autoclave. The can ends were removed from the jars and wash under water and blotted dry with paper towels. Several evaluations were taken in an order:
Enamel rating was performed on a can end after this process.
Roughness on rings was rated on a scale of 0 (worst) to 5 (best).
Adhesion test (following ASTM D 3359) was performed on a can end. Adhesion at flat area and adhesion at rings were rated separately, on a scale of 0 (worst) to 5 (best) by visual observation. Adhesion rating is the average value of adhesion at flat area rating and adhesion at rings rating.
Overall Total 5% Acetic Vapor Test performance is reported as Total Vapor % and calculated by:

$$Total Vapor \% = \frac{Sum of roughness rating and adhesion rating}{10} \times 100 \%$$

### Microcracking Test

To execute the micro-cracking test, a beading process needs to be undertaken on coated panel to simulate the fabrication of metal cans. As shown in FIG. X, a coated panel (40) with a dimension of 1″×4″ was inserted into the gap between the two rollers (10a and 10b) of a modified Metal Bead Roller and followed by a deformation process as running through the roller. With the function of a die, the two rollers with a large array of beading ripples (20 and 30) reproduce the beading patterns (50 and 60) from a range of can sizes (from 4 oz to 3 kg). The gap between the rollers was adjusted corresponding to the thickness of the tinplate. The film weight of coatings for this test is in a range of 3.0-3.5 gram/m². After the beading process, uncoated area of a panel including the edges and the backside was covered by vinyl tape (Yellow Heat Treated 3M 471), and followed by a 45 minutes immersion in acidified copper sulfate solution which will stain any area where cracking or micro-cracking has occurred on lacquer or coating due to the process. Acidified copper sulfate solution used in the experiment consists of 16 wt % copper sulfate, 5 wt % hydrochloric acid (35%), 79 wt % distilled water. All samples were taken out from copper sulfate solution, rinse with water and dried with paper towel, and evaluated for stain on a 1 to 5 scale with 5 being 0% stained area, 1 being ≥50% stained area and 0.5 interval on rating for every 5% change on stained area.

### Example 1: Synthesis of Polyester Polyol (Resin 1)

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point Aromatic 150 or 150ND (A150 or A150ND, available from ExxonMobil) was used to both encourage egress of the water condensate out of the reaction mixture and keep the reaction mixture viscosity at a reasonable level using the standard paddle stirrer. Isophthalic acid (IPA), terephthalic acid (TPA), sebacic acid (SA), 1,4-cyclohexane dimethanol (1,4-CHDM), 1,3-cyclohexane dimethanol (1,3-CHDM), trimethylolpropane (TMP), and Aromatic 150 were added to the reactor which was then completely assembled. The Fascat 4100 (monobutyltin oxide) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid enough, the stirring was started to encourage even heating of the mixture. At 150° C., the control of heating was switched to automated control and the temperature was ramped to 230° C. over the course of 4 h. The reaction was held at 230° C. and sampled every 1-2 h upon clearing until the desired acid value was reached (approximately 3 hours). The reaction mixture was then further diluted with A150ND to target a weight percent solid of 55%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

Charge

| | | | | Charge | |
|---|---|---|---|---|---|
| | | | | Weight | |
| | | Equi- | | (including | |
| Raw Material | Moles | valents | Weight | excess) | % Excess |
| Stage 1 | | | | | |
| IPA | 2.2750 | 4.5500 | 377.95 | 396.84 | 5 |
| TPA | 0.8750 | 1.7500 | 145.36 | 145.36 | 0 |
| Sebacic Acid | 0.3500 | 0.7000 | 70.81 | 70.81 | 0 |
| 1,3-CHDM | 1.8566 | 3.7131 | 267.74 | 281.12 | 5 |
| 1,4-CHDM | 1.5595 | 3.1190 | 224.90 | 236.14 | 5 |
| TMP | 0.2971 | 0.8912 | 39.86 | 40.25 | 1 |
| Total Charge | | | 1126.60 | | |
| Minus | | | 124.69 | | |
| Condensate | | | | | |
| Yield | | | 1001.91 | | |

| (Catalyst) | Concentration | |
|---|---|---|
| Fascat 4100 | 400 | 0.82 |
| (Processes | | |
| Solvent) | Wt. % | |
| A150ND | 10 | 130.15 |
| (Processes | | |
| Solvent) | Final Wt. % | |
| A150ND | 55 | 726.21 |

### Example 2: Synthesis of Polyester Polyol (Resin 2)

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point (A150 and A150ND) was used to both encourage egress of the water condensate out of the reaction mixture and keep the reaction mixture viscosity at a reasonable level using the standard paddle stirrer. Isophthalic acid (IPA), terephthalic acid (TPA), sebacic acid (SA), 1,3-cyclohexane dimethanol (1,3-CHDM), trimethylolpropane (TMP), and Aromatic 150 were added to the reactor which was then completely assembled. The Fascat 4100 (monobutyltin oxide) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid enough, the stirring was started to encourage even heating of the mixture. At 150° C., the control of heating was switched to automated control and the temperature was ramped to 230° C. over the course of 4 h. The reaction was held at 230° C. and sampled every 1-2 h upon clearing until the desired acid value was reached (approximately 3 hours). The reaction mixture was then further diluted with A150ND to target a weight percent solid of 55%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

Charge

| | | | | Charge | |
|---|---|---|---|---|---|
| | | | | Weight | |
| | | Equi- | | (including | |
| Raw Material | Moles | valents | Weight | excess) | % Excess |
| Stage 1 | | | | | |
| IPA | 2.2750 | 4.5500 | 377.95 | 396.84 | 5 |
| TPA | 0.8750 | 1.7500 | 145.36 | 145.36 | 0 |
| Sebacic Acid | 0.3500 | 0.7000 | 70.81 | 70.81 | 0 |
| 1,3-CHDM | 3.4161 | 6.8322 | 492.63 | 517.26 | 5 |
| TMP | 0.2971 | 0.8912 | 39.86 | 40.25 | 1 |
| Total Charge | | | 1126.60 | | |
| Minus | | | 124.69 | | |
| Condensate | | | | | |
| Yield | | | 1001.91 | | |

| (Catalyst) | Concentration | |
|---|---|---|
| Fascat 4100 | 400 | 0.82 |
| (Processes | | |
| Solvent) | Wt. % | |
| A150ND | 10 | 130.15 |
| (Processes | | |
| Solvent) | Final Wt. % | |
| A150ND | 55 | 726.21 |

### Example 3: Synthesis of Polyester Polyol (Resin 3)

This example describes the synthesis of a polyester polyol having lower sebacid acid (5 mole %) as compared to Resin 1.

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point (A150 and A150ND) was used to both encourage egress of the water condensate out of the reaction mixture and keep the reaction mixture viscosity at a reasonable level using the standard paddle stirrer. Isophthalic acid (IPA), terephthalic acid (TPA), sebacic acid (SA), 1,3-cyclohexane dimethanol (1,3-CHDM), trimethylolpropane (TMP), and Aromatic 150 were added to the reactor which was then completely assembled. The Fascat 4100 (monobutyltin oxide) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid enough, the stirring was started to encourage even heating of the mixture. At 150° C., the control of heating was switched to automated control and the temperature was ramped to 230° C. over the course of 4 h. The reaction was held at 230° C. and sampled every 1-2 h upon clearing until the desired acid value was reached (approximately 4 hours). The reaction mixture was then further diluted with A150ND to target a weight percent solid of 55%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

Charge

| | | | | Charge | |
|---|---|---|---|---|---|
| | | | | Weight | |
| | | Equi- | | (including | |
| Raw Material | Moles | valents | Weight | excess) | % Excess |
| Stage 1 | | | | | |
| IPA | 2.3625 | 4.7250 | 392.48 | 392.48 | 0 |
| TPA | 0.9625 | 1.9250 | 159.90 | 159.90 | 0 |
| Sebacic Acid | 0.1750 | 0.3500 | 35.40 | 35.40 | 0 |
| 1,3-CHDM | 3.4180 | 6.8360 | 492.91 | 497.84 | 1 |
| TMP | 0.2972 | 0.8917 | 39.88 | 41.07 | 3 |
| Total Charge | | | 1120.58 | | |
| Minus | | | 124.86 | | |
| Condensate | | | | | |
| Yield | | | 995.72 | | |

| (Catalyst) | Concentration | |
|---|---|---|
| Fascat 4100 | 400 | 0.79 |
| (Processes | | |
| Solvent) | Wt. % | |
| A150ND | 10 | 125.28 |
| (Processes | | |
| Solvent) | Final Wt. % | |
| A150ND | 55 | 695.06 |

### Example 4: Synthesis of Polyester Polyol (Resin 4)

This example describes the synthesis of a polyester polyol without sebacid acid.

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point (A150 and A150ND) was used to both encourage egress of the water condensate out of the reaction mixture and keep the reaction mixture viscosity at a reasonable level using the standard paddle stirrer. Isophthalic acid (IPA), terephthalic acid (TPA), 1,3-cyclohexane dimethanol (1,3-CHDM), trimethylolpropane (TMP), and Aromatic 150 were added to the reactor which was then completely assembled. The Fascat 4100 (monobutyltin oxide) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid enough, the stirring was started to encourage even heating of the mixture. At 150° C., the control of heating was switched to automated control and the temperature was ramped to 230° C. over the course of 4 h. The reaction was held at 230° C. and sampled every 1-2 h upon clearing until the desired acid value was reached (approximately 7 hours). The reaction mixture was then further diluted with A150ND to target a weight percent solid of 55%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

Charge

| | | | | Charge | |
|---|---|---|---|---|---|
| | | | | Weight | |
| | | Equi- | | (including | |
| Raw Material | Moles | valents | Weight | excess) | % Excess |
| Stage 1 | | | | | |
| IPA | 2.4500 | 4.9000 | 407.02 | 407.02 | 0 |
| TPA | 1.0500 | 2.1000 | 174.44 | 174.44 | 0 |
| 1,3-CHDM | 3.4159 | 6.8317 | 492.60 | 497.53 | 1 |
| TMP | 0.2970 | 0.8911 | 39.85 | 41.05 | 3 |
| Total Charge | | | 1113.91 | | |
| Minus | | | 124.87 | | |
| Condensate | | | | | |
| Yield | | | 989.04 | | |

| (Catalyst) | Concentration | |
|---|---|---|
| Fascat 4100 | 400 | 0.79 |
| (Processes | | |
| Solvent) | Wt. % | |
| A150ND | 10 | 124.54 |
| (Processes | | |
| Solvent) | Final Wt. % | |
| A150ND | 55 | 690.33 |

### Example 5: Synthesis of Polyester Polyol (Resin 5)

This example describes the synthesis of a polyester polyol having adipic acid (AD) as the aliphatic diacid.

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point (A150 and A150ND) was used to both encourage egress of the water condensate out of the reaction mixture and keep the reaction mixture viscosity at a reasonable level using the standard paddle stirrer. Isophthalic acid (IPA), terephthalic acid (TPA), adipic acid (AD), 1,3-cyclohexane dimethanol (1,3-CHDM), trimethylolpropane (TMP), and Aromatic 150 were added to the reactor which was then completely assembled. The Fascat 4100 (monobutyltin oxide) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid enough, the stirring was started to encourage even heating of the mixture. At 150° C., the control of heating was switched to automated control and the temperature was ramped to 230° C. over the course of 4 h. The reaction was held at 230° C. and sampled every 1-2 h upon clearing until the desired acid value was reached (approximately 3 hours). The reaction mixture was then further diluted With A150ND to target a weight percent solid of 55%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

Charge

| | | | | Charge | |
|---|---|---|---|---|---|
| | | | | Weight | |
| | | Equi- | | (including | |
| Raw Material | Moles | valents | Weight | excess) | % Excess |
| Stage 1 | | | | | |
| IPA | 2.2750 | 4.5500 | 377.95 | 377.95 | 0 |
| TPA | 0.8750 | 1.7500 | 145.36 | 145.36 | 0 |
| Adipic Acid | 0.3500 | 0.7000 | 51.14 | 51.14 | 0 |
| 1,3-CHDM | 3.4135 | 6.8270 | 492.26 | 497.18 | 1 |
| TMP | 0.2968 | 0.8905 | 39.82 | 41.02 | 3 |
| Total Charge | | | 1106.53 | | |
| Minus | | | 124.88 | | |
| Condensate | | | | | |
| Yield | | | 981.65 | | |

| (Catalyst) | Concentration | |
|---|---|---|
| Fascat 4100 | 400 | 0.78 |
| (Processes | | |
| Solvent) | Wt. % | |
| A150ND | 10 | 123.71 |
| (Processes | | |
| Solvent) | Final Wt. % | |
| A150ND | 55 | 685.10 |

### Example 6: Synthesis of Polyester Polyol (Resin 6)

This example describes the synthesis of a polyester polyol having 1,4-CHDA as the aliphatic diacid.

The polyols were produced using a resin kettle reactor setup controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point (A150 and A150ND) was used to both encourage egress of the water condensate out of the reaction mixture and keep the reaction mixture viscosity at a reasonable level using the standard paddle stirrer. Isophthalic acid (IPA), terephthalic acid (TPA), 1,4-cyclohexanedicarboxylic acid (CHDA), 1,3-cyclohexanedimethanol (1,3-CHDM), trimethylolpropane (TMP), and Aromatic 150 were added to the reactor which was then completely assembled. The Fascat 4100 (monobutyltin oxide) was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid enough, the stirring was started to encourage even heating of the mixture. At 150° C., the control of heating was switched to automated control and the temperature was ramped to 230° C. over the course of 4 h. The reaction was held at 230° C. and sampled every 1-2 h upon clearing until the desired acid value was reached (approximately 3 hours). The reaction mixture was then further diluted with A150ND to target a weight percent solid of 55%. This solution was filtered through a ˜250 μm paint filter prior to use in the formulation and application testing. It should be noted that the glycol excesses were determined empirically for the lab reactor and may be different depending on the partial condenser and reactor design used. The glycol:acid ratio was also manipulated to enable achieving the same molecular weight with simply different acid and hydroxyl end levels.

Charge

| | | | | Charge | |
|---|---|---|---|---|---|
| | | | | Weight | |
| | | Equi- | | (including | |
| Raw Material | Moles | valents | Weight | excess) | % Excess |
| Stage 1 | | | | | |
| IPA | 2.2750 | 4.5500 | 377.95 | 377.95 | 0 |
| TPA | 0.8750 | 1.7500 | 145.36 | 145.36 | 0 |
| Adipic Acid | 0.3500 | 0.7000 | 60.27 | 60.27 | 0 |
| 1,3-CHDM | 3.4166 | 6.8332 | 492.71 | 497.63 | 1 |
| TMP | 0.2971 | 0.8913 | 39.86 | 41.06 | 3 |
| Total Charge | | | 1116.15 | | |
| Minus | | | 124.87 | | |
| Condensate | | | | | |
| Yield | | | 991.28 | | |

| (Catalyst) | Concentration | |
|---|---|---|
| Fascat 4100 | 400 | 0.79 |
| (Processes | | |
| Solvent) | Wt. % | |
| A150ND | 10 | 124.78 |
| (Processes | | |
| Solvent) | Final Wt. % | |
| A150ND | 55 | 691.92 |

### Example 7: Synthesized Polyester Polyol Compositions and their Properties

Table 1 lists the compositions of Resins 1-6, and Table 2 lists their resin properties.

Glass transition temperature (Tg) was determined using a 02000 differential scanning calorimeter (DSC) from TA Instruments, New Castle, DE, US, at a scan rate of 20° G/min. Number average molecular weight (Mn) and weight average molecular weight (Mw) Mn were measured by gel permeation chromatography (GPC) using polystyrene equivalent molecular weight. Acid number was measured by using a procedure based on ASTM 07253-1 entitled “Standard Test Method for Polyurethane Raw Materials: Determination of Acidity as Acid Number for Polyether Polyols,” and hydroxyl number was measured using a procedure based on ASTM E222-1 entitled “Standard Test Methods for Hydroxyl Groups Using Acetic Anhydride.”

TABLE 1
Synthesized Polyester Polyols

| | Resin Composition as Charged | | | | | | | |
|---|---|---|---|---|---|---|---|---|
| | | | | Mole Ratio Based | | | | |
| | Mole Ratio Based on | | | on Total Acids (%) | | | | |
| | Total Alcohols (%) | | | | | Seba- | | |
| | 1,3- | 1,4- | | | | cic | | 1,4- |
| | CHDM | CHDM | TMP | TPA | IPA | acid | AD | CHDA |
| Resin 1 | 50 | 42 | 8 | 25 | 65 | 10 | | |
| Resin 2 | 92 | | 8 | 25 | 65 | 10 | | |
| Resin 3 | 92 | | 8 | 27.5 | 67.5 | 5 | | |
| Resin 4 | 92 | | 8 | 30 | 70 | | | |
| Resin 5 | 92 | | 8 | 25 | 65 | | 10 | |
| Resin 6 | 92 | | 8 | 25 | 65 | | | 10 |

TABLE 2
Resin Properties of Polyester Polyols

| | | | | Acid Number | OH Number |
|---|---|---|---|---|---|
| | Tg, C | Mn | Mw | Analyzed | Analyzed |
| Resin 1 | 55.4 | 12448 | 83595 | 0.9 | 39 |
| Resin 2 | 59.7 | 9558 | 63655 | 4.5 | 28 |
| Resin 3 | 55.5 | 8642 | 33774 | 4.4 | 35 |
| Resin 4 | 65.5 | 11035 | 112649 | 4.6 | 28 |
| Resin 5 | 58.8 | 8965 | 70747 | 4.0 | INS |
| Resin 6 | 65.9 | 10948 | 125612 | 5.3 | 27 |

### Example 8: Preparation of Gold Coating Formulations (GF1-3 and CGF1-6)

Coating formulations intended for gold color were prepared by using Resins 1-6. The gold formulations (GF 1-6) prepared from Resins 1-6 are listed in Table 3.

Prior to formulating, all polyester polyols were diluted in A150 ND to 50 wt. % solids. The solvent blends were made from the mixture of xylene, butanol and MAK at 30%, 30% and 40% by weight, respectively. An empty glass jar with a lid was labeled and pre-weighted to record the tare weight. For each formulation, Curaphen 40-856-B60, Desmodur® BL 2078/2, Nacure® XC296B and the solvent blend were weighed out respectively and added to the resin solution in order. The formulation was then sheared for 10-15 minutes at 1500 RPMs with a Cowles blade on a Dispermat™ high speed disperser. Once it was completed, the glass jar containing the formulation was then rolled overnight with slight agitation at ambient conditions. A food grade approved DesmodurO BL 2078/2 available from Covestro AG, and Curaphen 40-856-B60 available from Bitrez were chosen as blocked IPDI trimer and m-cresol phenolic-formaldehyde resin crosslinkers, respectively. A food grade approved NacureO® XC-296B available from King Industrials was chosen as H₃PO₄ catalyst.

TABLE 3
Gold Coating Formulations Based on Resins 1-6

| | | GF 1 | GF 2 | GF 3 | GF 4 | GF 5 | GF 6 |
|---|---|---|---|---|---|---|---|
| | Solids/ | Weight | Weight | Weight | Weight | Weight | Weight |
| Component | Active % | (g) | (g) | (g) | (g) | (g) | (g) |
| Resin 1 | 50% | 29.25 | | | | | |
| Resin 2 | 50% | | 29.25 | | | | |
| Resin 3 | 50% | | | 29.25 | | | |
| Resin 4 | 50% | | | | 29.25 | | |
| Resin 5 | 50% | | | | | 29.25 | |
| Resin 6 | 50% | | | | | | 29.25 |
| Curaphen 40-856-B60 | 60% | 9.38 | 9.38 | 9.38 | 9.38 | 9.38 | 9.38 |
| Desmodur ® BL 2078/2 | 60% | 3.75 | 3.75 | 3.75 | 3.75 | 3.75 | 3.75 |
| Nacure ® XC-296B | 28% | 0.90 | 0.90 | 0.90 | 0.90 | 0.90 | 0.90 |
| Solvent Blend | 0% | 6.73 | 6.73 | 6.73 | 6.73 | 6.73 | 6.73 |
| (Xylene, Butanol, | | | | | | | |
| MAK 30/30/40) | | | | | | | |

| | | | | | | |
|---|---|---|---|---|---|---|
| Total | 50.00 | 50.00 | 50.00 | 50.00 | 50.00 | 50.00 |
| % Total solids | 45.00% | 45.00% | 45.00% | 45.00% | 45.00% | 45.00% |
| % Polyester polyol on total binder | 65.00% | 65.00% | 65.00% | 65.00% | 65.00% | 65.00% |
| % IPDI on total binder | 10.00% | 10.00% | 10.00% | 10.00% | 10.00% | 10.00% |
| % Phenolic on total binder | 25.00% | 25.00% | 25.00% | 25.00% | 25.00% | 25.00% |
| % H₃PO₄ catalyst on total solids | 4.00% | 4.00% | 4.00% | 4.00% | 4.00% | 4.00% |

### Example 9: Coating Properties of Gold Formulations (GF 1-6)

The formulations prepared from Example 8 were applied on tin panels available from Lakeside Metals Inc.—0.23 mm thickness, 2.8 g/m² tin content, temper and annealing type T61CA (described as Lakeside substrate) by casting wet films with wire wound rods—RDS 10 (available from R.D. Specialties, Inc.). This yielded a final dry film weight to achieve approximately 6-8 grams/m². These samples based on Lakeside substrate were used for the testing of MEK double rubs, wedge bend, total retort, and 5% acetic acid vapor test. Separately, for microcracking test, the formulations were applied on Reynolds Metals Company—0.19 mm thickness, 2.2 g/m² tin content, temper and annealing type DR-8CA (described as Reynolds substrate) by casting wet films with wire wound rods—RDS 5 (available from R.D. Specialties, Inc.) which yielded a dry film weight of 3.0-3.5 gram/m².

The cast panels were placed in a rack and held vertically in an oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool to ambient conditions. A Sencon SI9600 coating thickness gauge was used to confirm the dry film weight of the applied coating. Once the coatings were made, coating performance tests including MEK double rubs, wedge bend, microcracking, total retort test, and 5% acetic acid vapor test were performed on them. The testing results are listed in Table 7.

TABLE 7
Coating Properties of Gold Formulations

| | MEK | Pass % | Micro- | Total | 5% Acetic |
|---|---|---|---|---|---|
| | Double | of wedge | cracking | Retort | acid vapor |
| Examples | Rubs | bend | rating | % | test |
| GF 1 | 100+ | 93% | 3.0 | 95% | 80% |
| GF 2 | 100+ | 93% | 3.5 | 91% | 40% |
| GF 3 | 100+ | 71% | 1.5 | 96% | 90% |
| GF 4 | 100+ | 72% | 2.0 | 99% | 90% |
| GF 5 | 100+ | 79% | 2.5 | 95% | 90% |
| GF 6 | 100+ | 77% | 2.5 | 97% | 60% |

As demonstrated above, this invention provides a non-BPA coating composition having improved coating properties for metal packaging application, which comprises a) a polyester polyol, which is the reaction product of the monomers comprising:
a) a polyester polyol, which is the reaction product of the monomers comprising:
   i. 1,3-cyclohexanedimethanol (1,3-CHDM) in an amount of 35-97 mole %, based on the total moles of i-iii,
   ii. a diol other than 1,3-CHDM in an amount of 0-50 mole %, based on the total moles of i-iii,
   iii. trimethylolpropane (TMP) in an amount of 3-15 mole %, based on the total moles of i-iii,
   iv. terephthalic acid (TPA) in an amount of 10-50 mole %, based on the total moles of iv-vi,
   v. isophthalic acid (IPA) in an amount of 50-90 mole %, based on the total moles of iv-vi, and
   vi. an aliphatic diacid in an amount of 0-20 mole %, and, based on the total moles of iv-vi, and
b) one or more crosslinkers selected from the group consisting of resole phenolic resin, isocyanate, and amino resin crosslinkers,

wherein said polyester polyol has a glass transition temperature (Tg) of 50-80° C.), acid number of 0-10 mgKOH/g, hydroxyl number of 15-45 mgKOH/g, number average molecular weight of 3000-20000 g/mole, and weight average molecular weight of 10000-150000 g/mole; and wherein said coating has a solvent resistance of greater than 70 MEK double rubs as measured by ASTM D7835 and a wedge bend resistance (% pass) of 70-100 as measured by the method of ASTM D3281.

The invention has been described in detail with reference to the embodiments disclosed herein, but it will be understood that variations and modifications can be effected within the spirit and scope of the invention.

1. A coating composition for metal packaging applications, comprising:
a. a polyester polyol, which is the reaction product of the monomers comprising:
i. 1,3-cyclohexanedimethanol (1,3-CHDM) in an amount of 35-97 mole %, based on the total moles of i-iii,
ii. a diol other than 1,3-CHDM in an amount of 0-50 mole %, based on the total moles of i-iii,
iii. trimethylolpropane (TMP) in an amount of 3-15 mole %, based on the total moles of i-iii,
iv. terephthalic acid (TPA) in an amount of 10-50 mole %, based on the total moles of iv-vi,
v. isophthalic acid (IPA) in an amount of 50-90 mole %, based on the total moles of iv-vi, and
vi. an aliphatic diacid in an amount of 0-20 mole %, and, based on the total moles of iv-vi, and
b. One or more crosslinkers selected from the group consisting of resole phenolic resin, isocyanate, and amino resin crosslinkers,
wherein said polyester polyol has a glass transition temperature (Tg) of 50-80° C.), acid number of 0-10 mgKOH/g, hydroxyl number of 15-45 mgKOH/g, number average molecular weight of 3000-20000 g/mole, and weight average molecular weight of 10000-150000 g/mole; and wherein said coating has a solvent resistance of greater than 50 MEK double rubs as measured by ASTM D7835 and a wedge bend resistance (% pass) of 70-100 as measured by the method of ASTM D3281.

2. The coating composition of claim 1, wherein said diol other than 1,3-CHDM (ii) is 1,4-cyclohexanedimethanol (1,4-CHDM).

3. The coating composition of claim 1, wherein said aliphatic diacid (vi) is one or more selected from succinic acid, adipic acid, sebacic acid, dodecanedioic acid, cyclohexane dicarboxylic acid, and dimer acid.

4. The coating composition of claim 1 wherein said aliphatic diacid (vi) is sebacic acid or adipic acid or a mixture thereof.

5. The coating composition of claim 1, wherein said polyester polyol (a) has a hydroxyl number of 25-35 mgKOH/g.

6. The coating composition of claim 1, wherein said polyester polyol (a) has a Tg of 55-70° C.

7. The coating composition of claim 1, wherein the crosslinker (b) is resole phenolic resin, isocyanate, or a mixture thereof.

8. The coating composition of claim 7, wherein the crosslinker (b) is a mixture of a resole phenolic resin and isocyanate, and wherein said resole phenolic resin is in an amount of 70-90 weight % and said isocyanate in an amount of 10-30 weight %, based on the total weight of the crosslinkers.

9. The coating composition of claim 1 wherein said resole phenolic resin comprises residues of m-substituted phenol.

10. (canceled)

11. The coating composition of claim 1 wherein said isocyanate is isophorone diisocyanate (IPDI).

12. (canceled)

13. The coating composition of claim 1, wherein said polyester polyol (a) in an amount of 50-90 weight % and said crosslinker (b) in an amount of 10-50 weight %, based on the total weight of (a) and (b).

14. The coating composition of claim 1, further comprising one or more organic solvents selected from the group comprising xylene, methyl amyl ketone, 2-butoxyethanol, ethyl-3-ethoxypropionate, toluene, butanol, cyclopentanone, cyclohexanone, ethyl acetate, butyl acetate, Aromatic 100, and Aromatic 150 available from ExxonMobil.

15. The coating composition of claim 1, wherein said coating has a solvent resistance of greater than 90 MEK double rubs as measured by ASTM D7835, and a wedge bend resistance (% pass) of 80-100 as measured by the method of ASTM D3281.

16. A coating composition for metal packaging applications, comprising:
a. a polyester polyol in an amount of 60-80 weight %, based on the total weight of (a), (b), and (c), which is the reaction product of the monomers comprising:
i. 1,3-cyclohexanedimethanol (1,3-CHDM) in an amount of 35-97 mole %, based on the total moles of i-iii,
ii. a diol other than 1,3-CHDM in an amount of 0-50 mole %, based on the total moles of i-iii,
iii. trimethylolpropane (TMP) in an amount of 3-15 mole %, based on the total moles of i-iii,
iv. terephthalic acid (TPA) in an amount of 10-50 mole %, based on the total moles of iv-vi,
v. isophthalic acid (IPA) in an amount of 50-90 mole %, based on the total moles of iv-vi, and
vi. an aliphatic diacid in an amount of 0-20 mole %, and, based on the total moles of iv-vi,
b. a resole phenolic resin in an amount of 15-30 weight % based on the total weight of (a), (b), and (c), and
c. isophorone diisocyanate (IPDI) in an amount of 5-15 weight % based on the total weight of (a), (b), and (c),
wherein said polyester polyol has a glass transition temperature (Tg) of 55 to 70° C., acid number of 0 to 10 mgKOH/g, hydroxyl number of 25 to 35 mgKOH/g, number average molecular weight of 5,000 to 20,000 mgKOH/g, and weight average molecular weight of 10,000 to 150,000; and wherein said coating has a solvent resistance of greater than 80 MEK double rubs as measured by ASTM D7835 and a wedge bend resistance (% pass) of 70-100 as measured by the method of ASTM D3281.

17. An article, of which at least a portion is coated with the coating composition of claim 1.
